(19) United States
(12) Patent Application Publication
(10) Pub. No.: US 2025/0216502 A1
(43) Pub. Date: Jul. 3, 2025

(54) SHIELDING MEMBER, RADAR APPARATUS

(71) Applicant: Stanley Electric Co., Ltd., Tokyo (JP)

(72) Inventor: Masayuki KANECHIKA, Tokyo (JP)

(73) Assignee: Stanley Electric Co., Ltd., Tokyo (JP)

(21) Appl. No.: 18/991,744

(22) Filed: Dec. 23, 2024

(30) Foreign Application Priority Data
Dec. 27, 2023 (JP) 2023-221326

(51) Int. Cl. G01S 7/02; G01S 13/931

(52) U.S. Cl. CPC G01S 7/027; G01S 13/931; G01S 2013/93277

(57) ABSTRACT

A shielding member for use in a radar apparatus including: a flat first portion made of foamed resin; a second portion made of non-foamed resin, disposed to surround the first portion so as to contact a side surface of the first portion; and a third portion made of non-foamed resin, disposed to contact each of one surface and the other surface of the first portion.

### CROSS-REFERENCE TO RELATED APPLICATION

This application claims the priority benefit under 35 U.S.C. § 119 to Japanese Patent Application No. JP 2023-221326 filed on Dec. 27, 2023, which disclosure is hereby incorporated in its entirety by reference

### BACKGROUND

### Technical Field

The present disclosure relates to a radar apparatus.

### Description of the Background Art

Japanese Unexamined Patent Application Publication No. 2021-099313 (Patent Document 1) describes a vehicle lamp having a lamp unit, a millimeter wave radar unit having an antenna, and a shielding member made of foamed resin that covers at least a portion of the front surface of the millimeter wave radar unit on which the antenna is provided.

By configuring the shielding member using foamed resin, it is possible to reduce transmission loss of millimeter waves transmitted and received by the millimeter wave radar unit.

However, when a shielding member is made of foamed resin, moisture from the air may enter the bubbles in the foamed resin during use, resulting in increased transmission loss and possibly degrading the performance of the radar apparatus.

In a specific aspect, it is an object of the present disclosure to prevent an increase in transmission loss when using a radar apparatus having a shielding member.

### SUMMARY

(1) A shielding member according to one aspect of the present disclosure is a shielding member for use in a radar apparatus including: a flat first portion made of foamed resin; a second portion made of non-foamed resin, disposed to surround the first portion so as to contact a side surface of the first portion; and a third portion made of non-foamed resin, disposed to contact each of one surface and the other surface of the first portion.

(2) A radar apparatus according to one aspect of the present disclosure is a radar apparatus including: a shielding member according to the above described (1); and a radar wave transmitter arranged with a gap between the shielding member and the radar wave transmitter.

According to the above configurations, it is possible to prevent an increase in transmission loss when using a radar apparatus having a shielding member.

### BRIEF DESCRIPTION OF THE DRAWINGS

FIG. 1 is a diagram schematically showing an internal structure of a vehicle lamp according to one embodiment.

FIG. 2A is a schematic cross-sectional view for explaining the arrangement of a millimeter wave radar unit and a shielding member.

FIG. 2B is a schematic plane view of a millimeter wave radar unit and a shielding member viewed from the shielding member side.

FIG. 3 is a partial enlarged view of a shielding member.

FIG. 4 is a diagram showing a calculation example of attenuation amount due to the incident angle of a millimeter wave on a shielding member.

FIG. 5 is a diagram showing measurement result of transmission loss in a shielding member of a working example.

### DESCRIPTION OF THE PREFERRED EMBODIMENTS

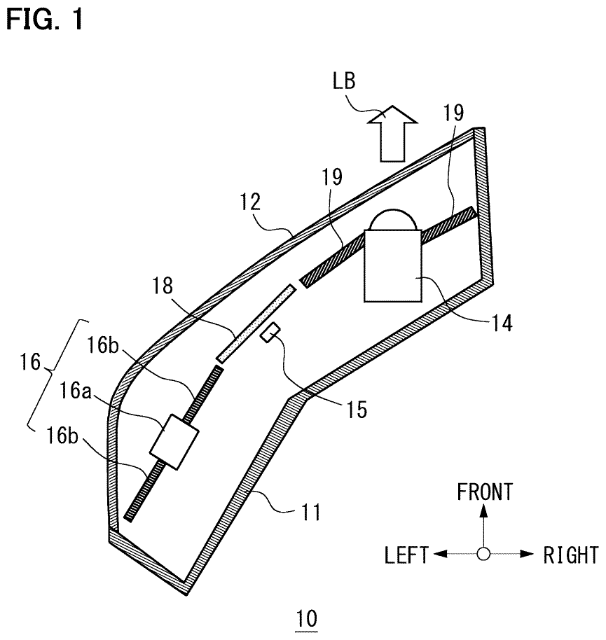

FIG. 1 is a diagram schematically showing an internal structure of a vehicle lamp according to one embodiment. The vehicle lamp 10 is mounted on a vehicle and used to irradiate the surroundings of the vehicle, such as a headlamp. FIG. 1 is a schematic diagram showing a cross section in a horizontal plane (or a plane parallel to the road surface) of a vehicle lamp 10 mounted on the left front of the vehicle (left headlamp), viewed from above.

The vehicle lamp 10 is configured to include a base 11, a transparent cover 12 held by the base 11, a headlamp unit 14, a millimeter wave radar unit (radar wave transmitter) 15, a light emitting unit 16, a shielding member 18, and an extension 19. The shielding member 18 is a type of extension member that makes the millimeter wave radar unit 15 difficult to see from the outside. A housing is formed by the base 11 and the transparent cover 12, and provided inside this housing are the headlamp unit 14, the millimeter wave radar unit 15, the light emitting unit 16, the shielding member 18, and the extension 19. Here, in the present embodiment, the radar apparatus is configured to include the radar unit 15 and the shielding member 18.

The headlamp unit 14 is configured to have a light source such as an LED (Light Emitting Diode) and a lens or reflector for distributing and emitting light from the light source. The headlamp unit 14 irradiates low beam (passing beam) and high beam (driving beam) light LB in the direction ahead of the vehicle.

The millimeter wave radar unit 15 has a transmitting and receiving surface on its front surface where a transmitting and receiving antenna for millimeter waves (radar waves) is provided. In this specification, the transmitting and receiving surface of the millimeter wave radar unit 15 (the surface in front of the millimeter wave radar unit 15) is also referred to as the antenna surface.

In detail, the millimeter wave radar unit 15 has a transmitting antenna and a receiving antenna on its transmitting and receiving surface (electromagnetic wave radiation surface). The millimeter wave radar unit 15 emits electromagnetic millimeter waves (radar waves) from the transmitting antenna and receives the reflected waves reflected by an object with the receiving antenna. By using the received reflected waves for signal processing, it is possible to detect the distance between the object, angle, and velocity. The millimeter wave radar unit 15 uses millimeter waves in the 76-81 GHz band, for example, and in particular millimeter waves in the 79 GHz band, but is not limited to this frequency band. Further, the antenna may have both transmitting and receiving functions.

The light emitting unit 16 has a light source 16a and a light guide 16b consisting of at least one light guide member that guides the light from the light source 16a. The light emitting unit 16 functions as a DRL (Daytime Running Lights) or a turn signal lamp, for example. The light source 16a has an LED or an incandescent bulb, and supplies its light to the light guide 16b, for example.

The millimeter wave radar unit 15 is disposed so that the normal direction of its antenna surface is inclined relatively to the outside of the vehicle (i.e., to the left direction in the case of a left headlamp) with respect to the optical axis of the headlamp unit 14.

The shielding member 18 is disposed with a gap between the member and the antenna surface of the millimeter wave radar unit 15. Further, at least one extension 19 is provided inside the lamp housing. The extension 19 is a design part that reflects or guides light, or makes internal structures difficult to see from the outside.

Here, in FIG. 1, the shielding member 18 is provided in a housing together with the millimeter wave radar unit 15. However, the radar apparatus may also have the millimeter wave radar unit 15 in a separate housing configured including a base separate from the base 11 and the shielding member 18. In such a case, the shielding member 18 constitutes the exterior of the vehicle, similar to the transparent cover 12 in FIG. 1.

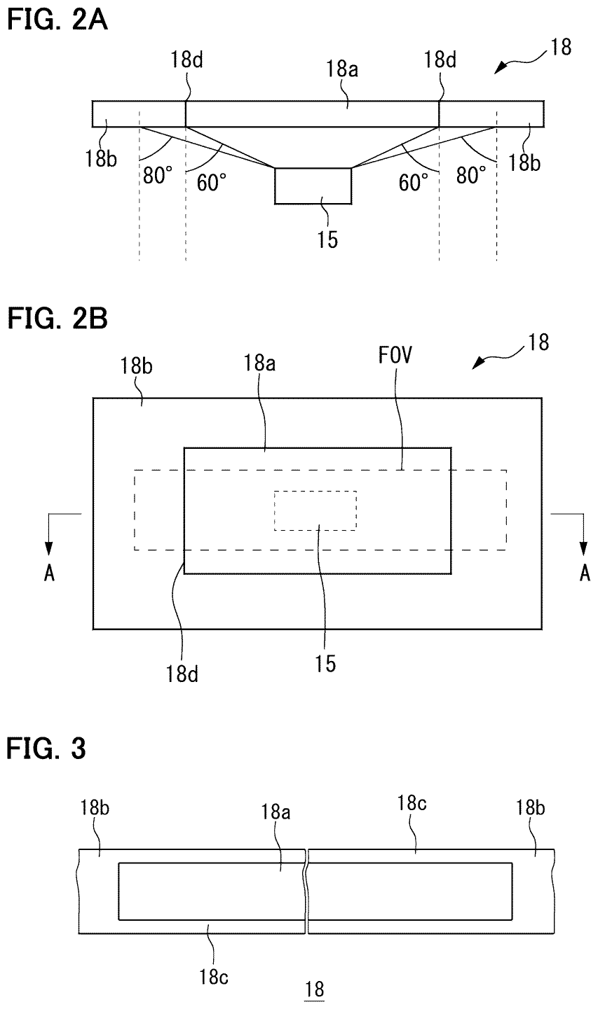

FIG. 2A is a schematic cross-sectional view for explaining the arrangement of the millimeter wave radar unit 15 and the shielding member 18. FIG. 2B is a schematic plane view of the millimeter wave radar unit 15 and the shielding member 18 viewed from the shielding member 18 side. Here, note that the cross-sectional view of FIG. 2A corresponds to the cross section along line A-A shown in FIG. 2B.

As shown in FIG. 2A and FIG. 2B, the shielding member 18 is a flat plate of approximately uniform thickness, for example, and is disposed so that one surface faces the antenna surface of the millimeter wave radar unit 15. It is preferable that the shielding member 18 is disposed so that it is perpendicular to the central axis or the reference axis of the antenna radiation pattern. Here, note that the antenna radiation pattern here refers to angular distribution of the electromagnetic wave intensity transmitted from the antenna surface of the millimeter wave radar unit 15, and generally has a distribution in which the intensity is maximum in the normal direction of the antenna surface, and the electromagnetic wave intensity decreases as the angle from the normal direction increases. The angle at which the intensity becomes −3 dB from the maximum intensity is called half-value width of the antenna pattern, and is 80°, for example.

The shielding member 18 has a flat first portion 18a made of foamed resin and a second portion 18b made of non-foamed resin. The first portion 18a is disposed in the center of the shielding member 18 in a plane view. The second portion 18b is provided so as to contact the side surface of the first portion 18a, and is arranged in an annular shape surrounding the first portion 18a in a plane view.

Further, as shown in an enlarged partial view in FIG. 3, both one surface and the other surface of the first portion 18a are provided with third portions 18c disposed so as to be in contact with each of the one surface and the other surface. These third portions 18c are made of non-foamed resin, similar to the second portion 18b. In the present embodiment, the second portion 18b and each of the third portions 18c are made integrally. As a result, the first portion 18a is in a state where its entire periphery is sealed with non-foamed resin.

The shielding member 18 can be a thickness of about 2.9 mm, for example. Further, each of the third portions 18c can have a thickness of 100 μm or less (less than the thickness of the first portion 18a). In the present embodiment, the combined thickness of the first portion 18a and each of the third portions 18c is 2.9 mm, and the thickness of the second portion 18b is also 2.9 mm. In other words, the shielding member 18 has a substantially uniform thickness overall.

Further, in the present embodiment, the second portion 18b and the third portions 18c are made of the same non-foamed resin. Furthermore, the first portion 18a is made of the foamed resin obtained by mixing air bubbles into the same material as the constituent material of the second portion 18b and the third portions 18c.

Here, “foamed resin” and “non-foamed resin” in the present embodiment will be described. “Foamed resin” is a resin formed by mixing gas (foaming gas) generated by a chemical reaction or physical change with a polymer or oligomer as a raw material. Specifically, it is a resin in which air bubbles are mixed into the resin by sealing carbon dioxide gas or the like in a transparent resin such as polycarbonate, acrylic, polyimide, or epoxy. This foamed resin can reduce the dielectric constant by sealing gas in the resin, so that it can greatly reduce the effect on electromagnetic waves. The foamed resin preferably has a bubble rate (the ratio of air bubbles to the total volume) of 50% or more. Further, “non-foamed resin” is a resin that has not been actively foamed as described above and does not have air bubbles. Here, in the present embodiment, resin that has a small amount of unintended air bubbles mixed in during manufacturing corresponds to “non-foamed resin” rather than “foamed resin”.

As an example, dielectric constant and attenuation amount at 0° incident angle were measured for a shielding member of a working example having a configuration according to the present embodiment and a shielding member of a comparative example made of foamed resin. In the working example, as described above, the shielding member was fabricated with a combined thickness of 2.9 mm for the first portion 18a and each of the third portions 18c, and a thickness of 100 μm for each of the third portions 18c. In the comparative example, the shielding member was fabricated by cutting the foamed resin into a flat plate shape with a thickness of 2.9 mm. As the resin in both the working example and the comparative example, polycarbonate was used. In the comparative example, the initial dielectric constant was 1.658 and attenuation amount was 0.035 dB, but after the water wettability test, the dielectric constant changed to 1.631 and the attenuation amount changed to 0.65 dB. In the working example, the dielectric constant was 1.83 and the attenuation amount was 0.11 dB, unchanged before and after the water wettability test.

Referring again to FIG. 2A, the arrangement of the millimeter wave radar unit and the shielding member will be described in detail. As shown in FIG. 2A, the shielding member 18 has a boundary 18d between the first portion 18a and the second portion 18b. This boundary 18d is annular (rectangular) in a plane view as shown in FIG. 2B. In the present embodiment, this boundary 18d is provided at a position where the incident angle of the millimeter waves radiated from the millimeter wave radar unit 15 to the shielding member 18 is 60°, at least at the A-A cross section. A position where the incident angle is 60°, is the position where the angle between the line connecting the outer edge of the antenna surface and the boundary 18d and the normal to the surface facing the antenna surface of the shielding member 18 is 60°, when the entire surface of the millimeter wave radar unit 15 facing the shielding member 18 is the antenna surface, as shown in the figure, for example. In other words, in the present embodiment, the first portion 18a is arranged in correspondence with a range where the incident angle of the millimeter wave is equal to or greater than 0° and less than or equal to 60° (a relatively small range), and the second portion 18b is arranged in correspondence with a range where the incident angle of the millimeter wave is greater than 60° (a relatively large range).

Here, taking into consideration manufacturing errors, etc., it is preferable to set the boundary 18d within a range of +5° from the preferred incident angle (60° in the above example).

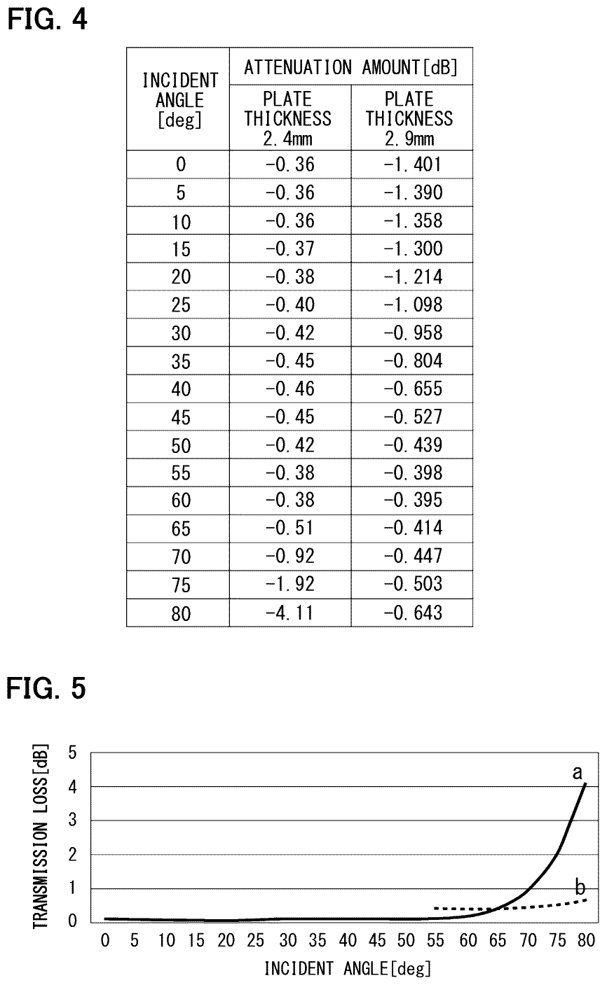

FIG. 4 is a diagram showing a calculation example of attenuation amount due to the incident angle of a millimeter wave on a shielding member. This calculation example was calculated using Fresnel's equation under the conditions of a frequency of 76.5 GHZ, horizontal polarization, dielectric constant of 2.7, and dielectric dissipation factor of 0.01. As shown in the calculation example, in the case of plate thickness of 2.4 mm where attenuation amount is the lowest at vertical incidence with an incident angle of 0°, when the incident angle is 80°, the attenuation amount becomes a large value which exceeds 4 dB. In the case of plate thickness of 2.9 mm, attenuation amount at vertical incidence is-1.4 dB, which is a large amount of attenuation.

Here, it is known that if dielectric constant of the shielding member is reduced by using a foamed resin, the effect on attenuation amount is reduced even at large incident angles. Therefore, by constructing the portion of the shielding member where the incident angle exceeds 60° (the above-described second portion 18b) using non-foamed resin with a plate thickness of 2.9 mm, and constructing the portion where the incident angle is within 60° (the above-described first portion 18a) using foamed resin, it is possible to reduce attenuation amount over the entire measurement range (field of view: FOV) of the shielding member 18.

Further, in order to fabricate the overall thickness of the shielding member 18 to be uniform at 2.9 mm, it is necessary to determine dielectric constant of the foamed resin so that attenuation amount is minimized when the plate thickness of the first portion 18a, which is the foamed resin portion, is 2.9 mm. Dielectric constant of foamed resin can be expressed by the following relational equation, so by using this relational equation, dielectric constant can be determined so as to minimize the transmission loss.

Dielectric constant of foamed resin=(1/(plate thickness/wavelength of millimeter wave radar))²

For example, when the plate thickness is 2.9 mm and the wavelength of the millimeter wave radar is 3.92 mm (equivalent to 76.5 GHZ), by setting the foaming rate so that dielectric constant of the foamed resin portion is 1.83, an optimal foamed resin can be obtained with a plate thickness of 2.9 mm.

Further, since the third portion 18c, which is a skin layer, is formed on both one surface and other surface of the first portion 18a, which is made of foamed resin, holes that could absorb moisture are not formed on the one surface and the other surface of the first portion 18a. Furthermore, since the second portion 18b is formed around the periphery (sides) of the first portion 18a, moisture absorption from the side of the first portion 18a is also suppressed. Here, the formation of the second portion 18b and the third portions 18c on the one surface and the other surface and around the periphery (side surface) of the first portion 18a can be achieved by insert molding, for example.

FIG. 5 is a diagram showing measurement result of transmission loss in a shielding member of a working example. Here, a shielding member of a working example was used in which combined thickness of the first portion 18a and each of the third portions 18c was 2.9 mm, and the thickness of the second portion 18b was also 2.9 mm. The shielding member of this working example has a dielectric constant of 1.83 and dielectric dissipation factor of 0.002 at the combined portion of the first portion 18a and each of the third portions 18c, and dielectric constant of 2.7 and dielectric dissipation factor of 0.01 at the second portion 18b.

As shown by characteristic line “a” in the figure, when millimeter waves are irradiated from the millimeter wave radar unit 15 to the first portion 18a (including the third portions 18c) of the shielding member of the working example, when the incident angle is in the range of 0 to 65°, attenuation amount is lower than that of the second portion 18b shown by characteristic line “b”. On the contrary, when the incident angle exceeds 65°, attenuation amount of the second portion 18b is lower than that of the first portion 18a. Based on the result of attenuation amount due to such incident angles, in this working example, the boundary 18d between the first portion 18a and the second portion 18b can be set at a position where the incident angle is 65°. When the manufacturing error as described above is taken into consideration, the boundary 18d can be set in the range of 65°+5°.

According to the above embodiment and working example, measures are taken toward moisture absorption when using foamed resin, making it possible to prevent an increase in transmission loss throughout the whole shielding member in various devices such as radar apparatus and vehicle lamps that use the same. Further, since the shielding member has a simple, flat plate-like structure as a whole, the strength of the shielding member can also be improved.

Here, note that the present disclosure is not limited to the content of the above described embodiment, and various modifications can be made within the scope of the gist of the present disclosure. For example, the specific numerical values and other conditions given in the working example are examples to aid in understanding the present disclosure, and these conditions do not limit the scope of application of the present disclosure. Specifically, for example, the above-described method of determining the position of the boundary 18d (corresponding to an incident angle of 60° as an example in the embodiment) is merely one example, and a suitable value can change depending on various conditions such as material and thickness of foamed resin and non-foamed resin used to configure the shielding member 18. In other words, in the same manner as one example shown in FIG. 5, by determining the range of incident angle in which the transmission loss in the foamed resin becomes smaller than that in the non-foamed resin, the boundary 18d between the first portion 18a and the second portion 18b can be determined based on the determined range.

Further, in the above embodiment, a headlamp is given as an example of a vehicle lamp, but a vehicle lamp is not limited to a headlamp, and the vehicle lamp may be a tail lamp, a backlight, etc. Furthermore, in the above embodiment, inside of the housing of a vehicle lamp is given as an example of the location where the radar apparatus is installed, but the location is not limited to inside the housing, and the radar apparatus may be installed in any location.

The present application is based on, and claims priority from, JP Application Serial Number, 2023-221326 filed on Dec. 27, 2023, the disclosure of which is hereby incorporated by reference herein in its entirety.

### DESCRIPTION OF SYMBOLS

10: Vehicle lamp
11: Base
12: Transparent cover
14: Headlamp unit
15: Millimeter wave radar unit
16: Light emitting unit
18: Shielding member
18a: First portion
18b: Second portion
18c: Third portion
18d: Boundary

What is claimed is:

1. A shielding member for use in a radar apparatus comprising:
a flat first portion made of foamed resin;
a second portion made of non-foamed resin, disposed to surround the first portion so as to contact a side surface of the first portion; and
a third portion made of non-foamed resin, disposed to contact each of one surface and the other surface of the first portion.

2. The shielding member according to claim 1,
wherein the combined thickness of the first portion and the third portion is approximately the same as the thickness of the second portion.

3. The shielding member according to claim 1,
wherein the second portion and the third portion are integrally formed.

4. The shielding member according to claim 1,
wherein the thickness of the third portion is less than the thickness of the first portion.

5. The shielding member according to claim 1,
wherein the second portion and the third portion are made of the same material.

6. The shielding member according to claim 1,
wherein the first portion is made of the foamed resin in which air bubbles are mixed into the same material as the constituent material of the second portion and the third portion.

7. A radar apparatus comprising:
a shielding member according to claim 1; and
a radar wave transmitter arranged with a gap between the shielding member and the radar wave transmitter.

8. The radar apparatus according to claim 7,
wherein the shielding member has the first portion disposed in a range where an incident angle of a radar wave is relatively small, and the second portion disposed in a range where an incident angle is relatively large.

9. The radar apparatus according to claim 8,
wherein a boundary between the first portion and the second portion is determined based on a range of an incident angle in which transmission loss in the foamed resin is smaller than transmission loss in the non-foamed resin.
